(19) United States
(12) Patent Application Publication
(10) Pub. No.: US 2019/0093816 A1
(43) Pub. Date: Mar. 28, 2019

(54) Apparatus And System For Securing Liquid Dispenser During Dispensing Procedure And Methods Thereof

(71) Applicants: SARA HAWE, BARRINGTON, IL (US); MICHAYLA HERR, LAKE BARRINGTON, IL (US); JOE WOLFF, SOUTH BARRINGTON, IL (US); CONNOR ABEL, BARRINGTON, IL (US); HANNA VANNESS, BARRINGTON, IL (US)

(72) Inventors: SARA HAWE, BARRINGTON, IL (US); MICHAYLA HERR, LAKE BARRINGTON, IL (US); JOE WOLFF, SOUTH BARRINGTON, IL (US); CONNOR ABEL, BARRINGTON, IL (US); HANNA VANNESS, BARRINGTON, IL (US)

(21) Appl. No.: 16/140,036

(22) Filed: Sep. 24, 2018

Related U.S. Application Data
(60) Provisional application No. 62/562,259, filed on Sep. 22, 2017.

(51) Int. Cl. F16M 11/10; F16M 11/18

(52) U.S. Cl. CPC F16M 11/10; A47B 13/16; A47B 2200/0043; F16M 11/18

(57) ABSTRACT

A container stand apparatus and system for facilitating the complete or near complete dispensing of liquids or beverages from a container that incorporates a dispenser or spigot that is not level with the bottom of the container. Depending on the amount of beverage in the container, and thus the weight of the container, the container stand automatically leans or tilts in such a manner so as to fully or completely or near fully or completely dispense the beverage from the container through the dispenser or spigot, especially in cases in which a small amount of liquid or beverage would normally remain at the bottom of the container.

### CROSS-REFERENCE TO RELATED APPLICATIONS

This application claims priority to U.S. Provisional Patent Application No. 62/562,259, filed Sep. 22, 2017, entitled Apparatus And Systems For Securing Liquid Dispenser During Dispensing Procedure And Methods Thereof, which is hereby incorporated by reference in its entirety as though fully set forth herein.

### BACKGROUND

### a. Technical Field

The present disclosure relates to an apparatus and system for facilitating the complete or almost complete dispensing of liquids from a container using a liquid or beverage dispenser or spigot. In particular, the present disclosure relates to a device for automatically leaning, sloping, tilting or in other ways orienting a liquid or beverage container in such a manner so as to fully or completely or near fully or completely dispense the beverage from the container through the dispenser or spigot, especially in cases in which a small amount of liquid or beverage would normally remain at the bottom of the container, below the spigot line.

The present disclosure is further configured with springs to begin to slope or tilt when the amount of liquid in the container is reduced to a level that may not dispense when the handle of the spigot is depressed or pulled in order to dispense the liquid. Further, the instant disclosure is configured to accept and securely confine or hold the beverage container while the container is in the initial position when full or partially full of liquid and in the sloping position as the container dispenses an appreciable amount of liquid.

### b. Background of Disclosure

There are numerous types of beverage containers and/or coolers that are used for various reasons, including to keep liquids cold for events, such as sporting events, picnics and parties, etc. In general, a beverage container or cooler is much larger than a standard glass or cup size in order to provide beverages to many of the individuals at the event. In doing so, there is no need for individual cans or bottles of the beverage as each individual can dispense the beverage into their own cup or mug.

Quite often, the container or cooler is insulated to keep the liquid contents cold or hot, depending on the need. As an example of an insulated beverage container is the Igloo 5-Gallon Heavy-Duty Beverage Cooler, which hold about 5 gallons of beverage. The Igloo cooler contains a top that is removable for filling the cooler with ice and beverage and a dispensing mechanism such as a spigot, for dispensing the beverage. The cooler is also insulated and claims to keep ice from melting for up to three days. The Igloo cooler uses a drip-resistant spigot to dispense the beverage from the cooler. In theory, the 5-gallon cooler can fill about 53 12-ounce cups, or about 38 of the standard size 16.9-ounce water bottles. Accordingly, instead of bringing 38 bottles of water to a party, one can bring the 5-gallon container.

One of the problems with such a container or cooler is that the beverage dispensing mechanism or spigot is located on the side of the container an inch or so higher from the bottom of the container. This is done in order to keep the bottom of the dispensing spigot from brushing the table or ground in which the container is placed. However, based on the spigot placement, the act of dispensing the beverage when the container is sitting upright as intended will never allow for all of the beverage to completely dispense from the container. Some of the beverage will remain in the container.

In tests, the amount of liquid or beverage remaining in the container can be as much as one quart or more. This remaining liquid can be wasteful and costly. To the extent that the remaining liquid is water, there is the waste of water and the cost involved. To the extent that the liquid wasted is a beverage such as lemonade or Gatorade, the amount wasted can add up and be costly.

In order to remove the remaining liquid, one can turn the container upside down, and allow the beverage to flow out of the top of the container, which can be messy. Additionally, one can tilt or slope the container in such a manner as to allow the remaining beverage to completely dispense through the dispensing mechanism or spigot. This usually takes two people as one has to hold the container at an angle and one has to dispense the liquid through the dispensing mechanism. This method can also be messy as the sloping container can slide from the person holding it at an angle. This method can also be dangerous if the liquid being dispensed is warm or hot.

Previous inventions attempt to solve this issue with various container configurations and designs. As an example, U.S. Pat. No. 4,762,241, titled Container with Supplemental Opening for Extracting Contents, discloses a container especially for use with viscous substances that has both a primary opening and a supplemental opening. The primary opening is at an upper point in the container, whereby contents are extracted due to gravity, when tilting the container. A supplemental opening with removable closure is provided at a lowermost point in the container, for also extracting contents under gravity feed. The supplemental opening is preferably located at the end of a slope, causing material in the container to accumulate over the supplemental opening. Particular removable closures include plugs, tethered plugs and frangible panels. However, among other shortcomings, the device utilizes two removable closures, which increases the cost of the device.

Another device ostensibly used to dispense all of the liquid in a container is the Tip-N-Tap™ ABS Portable Dispenser. In theory, the device is an economical way to dispense liquids from large volume jugs. It is made of ABS plastic and uses Buna-N O-rings & seals. The device screws onto most one gallon glass or plastic jugs and accepts jugs with a 38 mm neck. The device has a secure, no-leak seal and is rust-proof and dishwasher safe. However, among other shortcomings, the device can only be used with a particular type of glass or plastic jug that can be screwed into the base.

As such there is a need for an apparatus and system for facilitating the complete and total dispensing of liquids or beverages from a container using the original dispenser or spigot on the container. There is a need for a device that automatically leans or tilts the beverage container in such a way as to fully or completely, or nearly completely, dispense the beverage from the container through the dispensing mechanism or spigot, including dispensing of the small amount of beverage that would normally remain at the bottom of the container, below the spigot.

The foregoing is intended only to illustrate the present technical field and background art and should not be taken as a limitation or disavowal of claim scope.

### BRIEF SUMMARY

Accordingly, the present disclosure is an improved container stand apparatus and system for facilitating the complete, or near complete, dispensing of liquids from the container using a liquid or beverage dispenser or spigot on the container, without modifying the container in any way. In practice, the present disclosure relates to a container stand apparatus configured to automatically lean, slope, tilt or in other ways orient the liquid or beverage container in such a manner so as to fully or completely dispense any and all liquid or beverage from the container through the originally located dispenser or spigot. At a minimum, the present device is an improved container stand that can dispense more beverage than if the container remained at its original upright position.

The present disclosure is configured to accept and securely confine a standard size container, such as a 5-gallon beverage cooler with a spigot that is located an inch or more above the bottom of the cooler, such that when the cooler spigot is depressed or in other ways actuated to dispense the beverage, a small portion of the beverage will not be dispensed. The present disclosure is configured using a spring design (although other designs are contemplated) to hold the container in a level position and when the amount of beverage inside the container reaches a maximum threshold, the springs will begin to pull down the top or ceiling of the apparatus, which will then automatically begin to tilt or slope in a way that the beverage inside will move toward the back side of the spigot (front side of the container). As such, when the spigot is depressed or actuated, the beverage, which would normally be below the back of the spigot, will be dispensed through the spigot. Additionally, as more of the beverage is dispensed, the amount of beverage in the container will be further reduced thereby reducing the weight and allowing the springs to further pull down the top for additional tilting or sloping of the container (to be removed through the spigot), until all or almost all of the beverage has been removed through the spigot.

The present disclosure is an improved container stand utilizing a spring design that automatically tilts based on the amount of liquid (and thus the weight) in the container and provides a holding structure, such as extension rods, to hold the container in place during the automatic tilting process. The holding structure on the tilting stand can be permanently fixed to accept and hold a standard cooler, such as the Igloo 5-Gallon Cooler described herein, or the structure can be removable and relocatable to accommodate different size coolers.

The present disclosure is further an improved container stand that can be used with any size container or cooler to automatically tilt and dispense all of the liquid or beverage from the container without leaving any liquid remaining in the container, and specifically under the spigot, when the container is in the upright position.

The present disclosure further provides for a stand apparatus configured for decoration in a particular schools colors or for a particular team logo or mascot.

As a non-limiting example, the instant disclosure relates to a wooden, plastic or metal container stand, incorporating two springs, that is configured to securely accept and support a standard 5-gallon cooler that uses a spigot to dispense the beverage inside. The spigot on the standard cooler is at least an inch or more above the bottom of the cooler. When the cooler is full, the stand will support the container in its intended upright and straight position. As more liquid is dispensed through the spigot, the cooler will weigh less and when enough liquid has been dispensed below the maximum threshold, the springs will experience less resistance and begin to pull down the top of the apparatus. The top of the apparatus will then begin to tilt such that the liquid in the cooler will move towards the back end of the spigot, where it can be dispensed. This process will continue with the liquid being dispensed, the container weighing less, the stand tilting even more, and the remaining liquid moving toward the spigot, until there is very little liquid remaining, possibly a table spoon or less.

As such, it is an objective of the present disclosure to provide a container or cooler stand apparatus, system and methods for facilitating the dispensing of a liquid or beverage from a standard container or cooler by automatically tilting or sloping the container to dispense the remaining liquid that would not be otherwise dispensed.

Additional objectives and advantages of the present disclosure will become apparent to one having ordinary skill in the art after reading the specification in light of the drawing figures, however, the spirit and scope of the present invention should not be limited to the description of the embodiments contained herein.

### BRIEF DESCRIPTION OF THE DRAWINGS

FIG. 1A is a front view of an exemplary container according to the prior art.

FIG. 1B is a side view of an exemplary container according to the prior art.

FIGS. 2A, 2B and 2C are front views of an exemplary container according to the prior art.

FIGS. 3A, 3B and 3C are side views of an exemplary container according to the prior art.

FIG. 4A is a front perspective view of an exemplary embodiment of a container stand apparatus in accordance with the present disclosure.

FIG. 4B is a side perspective view of an exemplary embodiment of a container stand apparatus in accordance with the present disclosure.

FIG. 5 is a drawing of an exemplary embodiment of a container stand base in accordance with the present disclosure.

FIG. 6 is a drawing of an exemplary embodiment of a container stand top in accordance with the present disclosure.

FIG. 7 is a bottom perspective view of an exemplary embodiment of a container stand apparatus in accordance with the present disclosure.

FIG. 8A is a front perspective view of an exemplary embodiment of a container stand apparatus and standard container in accordance with the present disclosure.

FIG. 8B is a side perspective view of an exemplary embodiment of a container stand apparatus and standard container in accordance with the present disclosure.

### DETAILED DESCRIPTION

As stated herein, the objective of the present disclosure is to provide an improved container stand apparatus and system for facilitating the complete or near complete dispensing of liquids from the container using a liquid or beverage dispenser or spigot located above the bottom of the container. In doing so, the present disclosure relates to a container stand apparatus configured to automatically lean, slope, tilt or in other ways orient the liquid or beverage container in such a manner so as to fully or completely or near fully or completely dispense any and all liquid or beverage from the container through the originally located dispenser or spigot.

The present disclosure is further configured to accept and securely secure a container, for example, a 5-gallon beverage cooler, with a spigot that may be located an inch or more above the bottom of the cooler. This configuration is such that when the spigot is actuated to dispense the beverage, a small portion of the beverage will not be dispensed. The container stand apparatus is configured such that when the amount of beverage inside the container reaches a maximum threshold (by weight or volume), the stand apparatus will automatically begin to tilt or slope in a way that the beverage inside will move toward the back side of the spigot. The maximum threshold will vary depending on the size and/or weight of the container containing the liquid. As the liquid is dispensed, the container stand will keep the container upright in its original position. When enough liquid has been dispensed and the container and remaining liquid reaches the maximum threshold, the container stand will begin to slant due to the springs, as described below. As such, when the spigot is depressed or actuated, the beverage will be dispensed through the spigot. As more beverage is dispensed, the amount of beverage in the container will be further reduced, thereby reducing the weight on the stand, and allowing additional tilting or sloping of the container, until all or almost all of the beverage has been removed through the spigot.

The present disclosure is further configured with holding structure, such as extension rods or some other means, to hold the container in place during the automatic tilting process. As described herein, the holding structure on the stand apparatus can be permanently fixed to accept and hold the container or cooler, or the holding structure can be removable and relocatable to accommodate different size coolers. As such, the present disclosure is an improved container stand that can be used with any size container or cooler to automatically tilt and dispense all or most of the liquid or beverage from the container without leaving any liquid (or a very reduced amount) remaining in the container.

In the foregoing discussion, and in particular, the description of the preferred embodiment herein, is intended only to illustrate and explain these objectives and should not be taken as a disavowal of claim scope. Other configurations can be used to accomplish the same result.

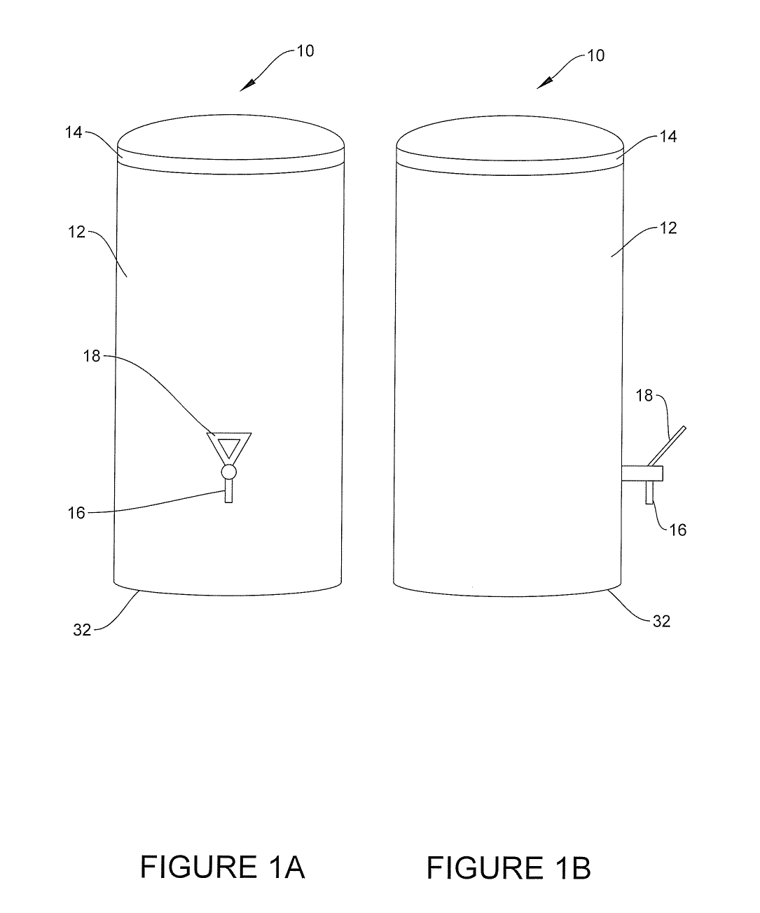

Referring to the drawings, wherein like reference numerals refer to the same or similar features in the various views, FIGS. 1A and 1B are front and side views, respectively, of an exemplary embodiment of a container or cooler 10 in accordance with the prior art. As detailed above, an example of such a cooler 10, in this case an insulated beverage cooler, is the Igloo 5-Gallon Heavy-Duty Beverage Cooler, which hold about 5 gallons of beverage. The container or cooler 10 comprises a container body 12 that holds or contains the liquid or beverage, a top 14 that is removable for filling the container body 12 with ice and beverage, and a dispensing mechanism or spigot 16 for dispensing the beverage out of the container body 12. The top 14 is usually a screw-on or pressure-fit top 14. The screw-on top 14 has threads that mate with threads on the inside of the container body 12 as understood by one having ordinary skill in the art. The pressure-fit top 14 is sized and configured to be pressed into position on the top of the container body 12 once the container body 12 is filled with ice and beverage, etc., as also understood by one having ordinary skill in the art.

Although there are many types of spigots 16, the Igloo cooler 10 described above uses a drip-resistant spigot 16 to dispense the beverage from the container body 12. Other spigot types 16 include bail and trigger dispensers, gate valve dispensers, among others. The spigot 16 comprises a handle or button 18, which is pulled, pushed or depressed to actuate the spigot 16 and dispense the liquid or beverage from the container body 12.

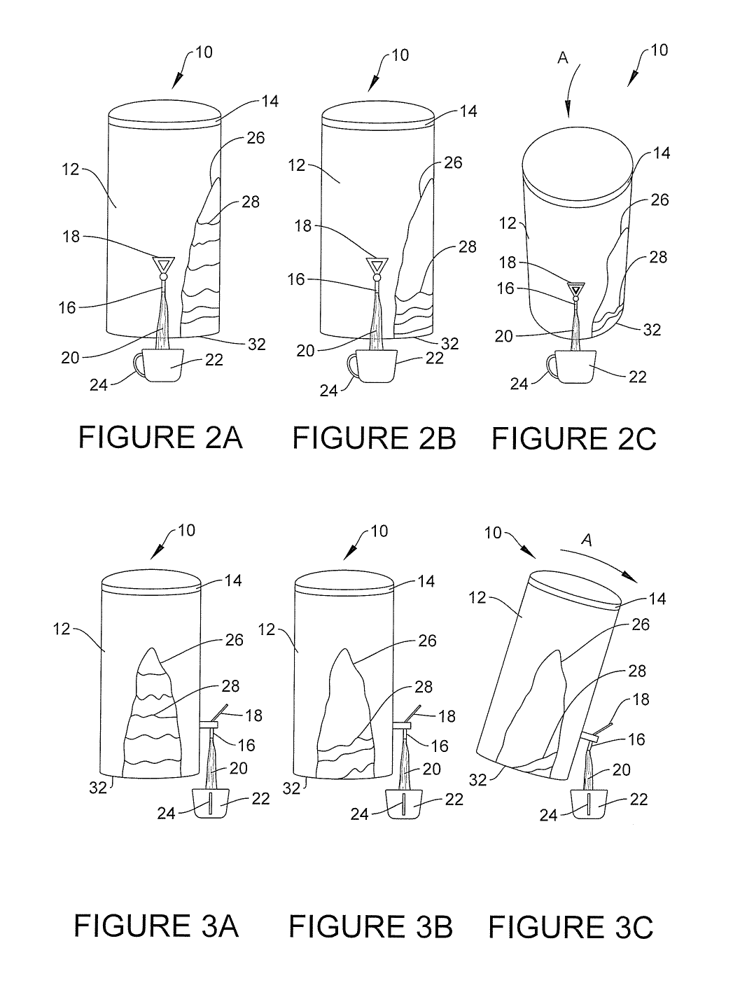

FIGS. 2A-C and 3A-C are front and side views, respectively, of an exemplary embodiment of a container or cooler 10 in accordance with the prior art dispensing liquid or beverage 20 from the container 10 into a cup 22 with a cup handle 24. FIGS. 2A-C show the front view of a full container 10 (FIG. 2A) to a partially full container 10 at the spigot line (FIG. 2B), to the manual tilting forward of the container 10 (FIG. 2C) to dispense the remaining liquid from the container 10.

FIGS. 2A-C also show a cut-away 26 and the remaining liquid 28 inside the container body 12. At the beginning, the container body 12 is full of liquid 28 (FIG. 2A). As the liquid 28 is dispensed, the level of liquid 28 in the container body 12 declines to the point that the level is lower than where the spigot 16 attaches to the container body 12 (FIG. 2B). At this point in time, actuating the handle 18 of the spigot will not dispense any additional liquid 28. Instead, the container 10 must be tilted forward (shown as arrow A) in order to dispense liquid 20 out of the spigot 16 and into the cup 22.

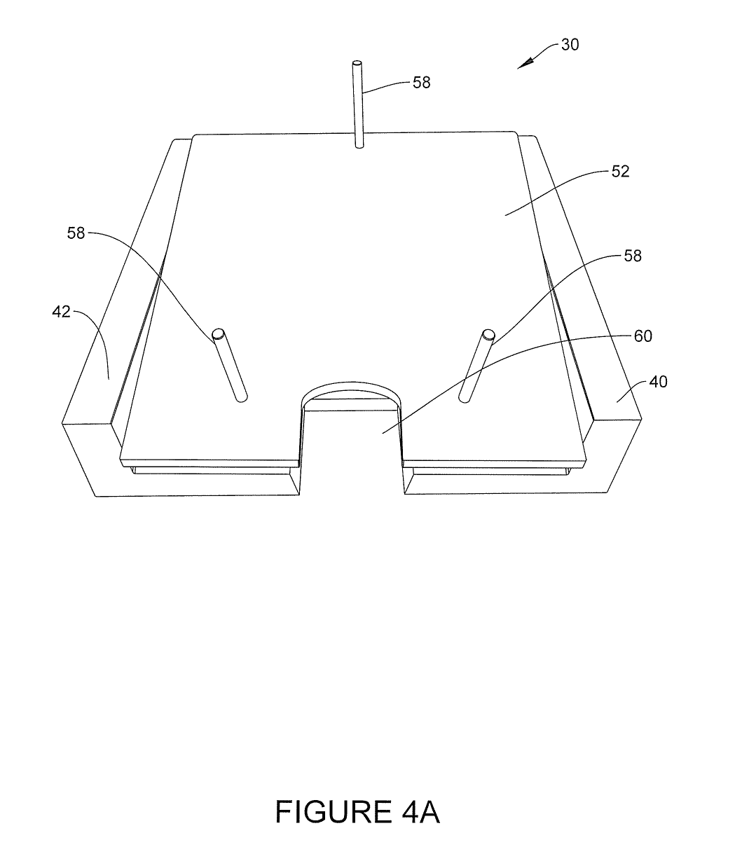

Similarly, FIGS. 3A-C show the side view of a full container 10 (FIG. 3A) to a partially full container 10 at the spigot line (FIG. 3B), to the manual tilting forward of the container 10 (FIG. 3C) to dispense the remaining liquid 20 from the container 10.

FIGS. 3A-C also show a cut-away 26 and the remaining liquid 28 inside the container body 12. At the beginning, the container body 12 is full of liquid 28 (FIG. 3A). As the liquid 28 is dispensed, the level of liquid 28 in the container body declines to the point that the liquid 28 level is lower than where the spigot 16 attaches to the container body 12 (FIG. 3B). At this point in time, actuating the handle 18 of the spigot 16 will not dispense any additional liquid 28. Instead, the container 10 must be tilted forward (shown as arrow A) in order to dispense liquid 20 out of the spigot 16 and into the cup 22.

As described herein, the present disclosure provides an improved container stand apparatus 30, system 100 and methods for facilitating the complete or near complete dispensing of liquids 20 from the container 10 using a liquid or beverage dispenser or spigot 16 located above the bottom of the container 32. In doing so, the present disclosure relates to a container stand apparatus 30 configured to automatically lean, slope, tilt or in other ways orient the liquid or beverage container 10 in such a manner so as to fully or completely dispense any and all liquid or beverage 20 from the container 10 through the originally located dispenser or spigot 16.

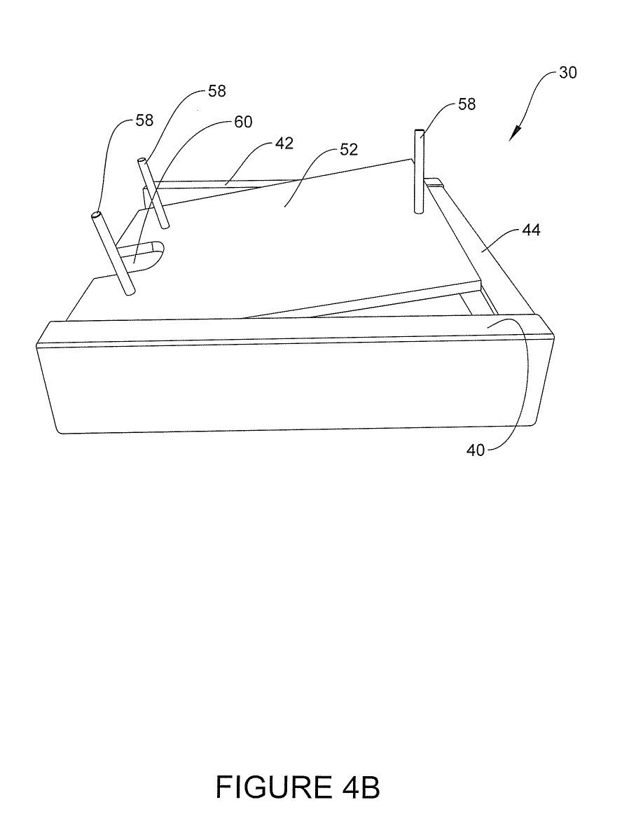

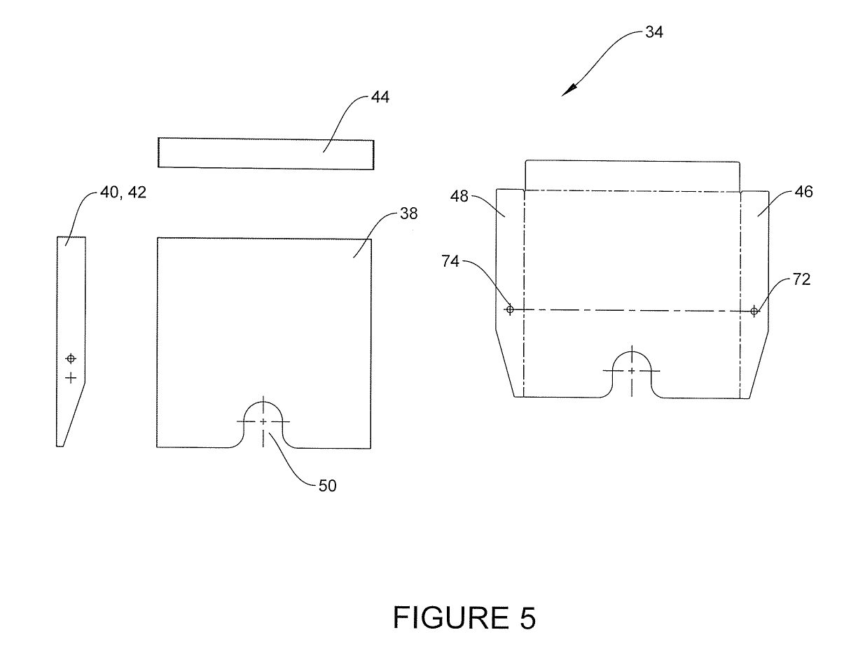

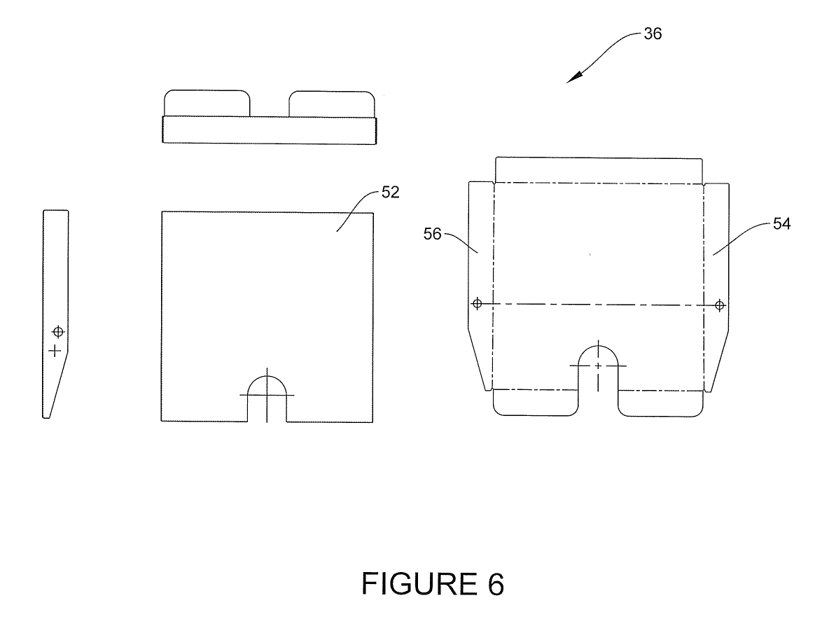

FIGS. 4A, 4B, 5 and 6 show the front perspective and side perspective views, and dimensional drawings, respectively, of the container stand apparatus 30 (in the partially tilted position). The container stand apparatus 30 comprises a stand base 34 (see also FIG. 5) and a stand top 36 (see also FIG. 6).

The stand base 34 comprises the floor 38, right side 40, left side 42, back side 44, right lower bias side 46 and left lower bias side 48. The dimensions of the preferred embodiment are shown on FIG. 5, however, different dimensions can be used for different sized containers 10. The floor 38 contains a lower indent 50 to facilitate filling large bottles or cups 22 without spilling.

The stand top 36 comprises the ceiling 52, the right upper bias side 54, the left upper bias side 56, along with holding structure, for example extension rods 58. In the preferred embodiment, three extension rods 58 can be used to secure the container 10 to the container stand 30 during the dispensing and tilting operations. Alternatively, other methods can be used for the container stand 30 to securely accept and hold the container 10. The dimensions of the preferred embodiment are shown on FIG. 6, however, again different dimensions can be used for different sized containers 10. The ceiling 52 also contains an upper indent 60 to facilitate filling large bottles or cups 22 without spilling.

As shown in FIGS. 4A and 4B, the floor 38, right side 40, left side 42 and back side 44 can be assembled to frame the container stand 30 and provide support for the container 10. Additionally, the ceiling 52 provides support for the container 10 and holds it in place during tilting. The right and left upper and lower bias sides 46, 48, 54, 56 provide the limits of the tilting both when the container 10 is full (straight and level) to when the container 10 has dispensed much of the liquid 20 and has reached the maximum threshold (starting to tilt) to when the container 10 has dispensed with almost all of the liquid (full tilt).

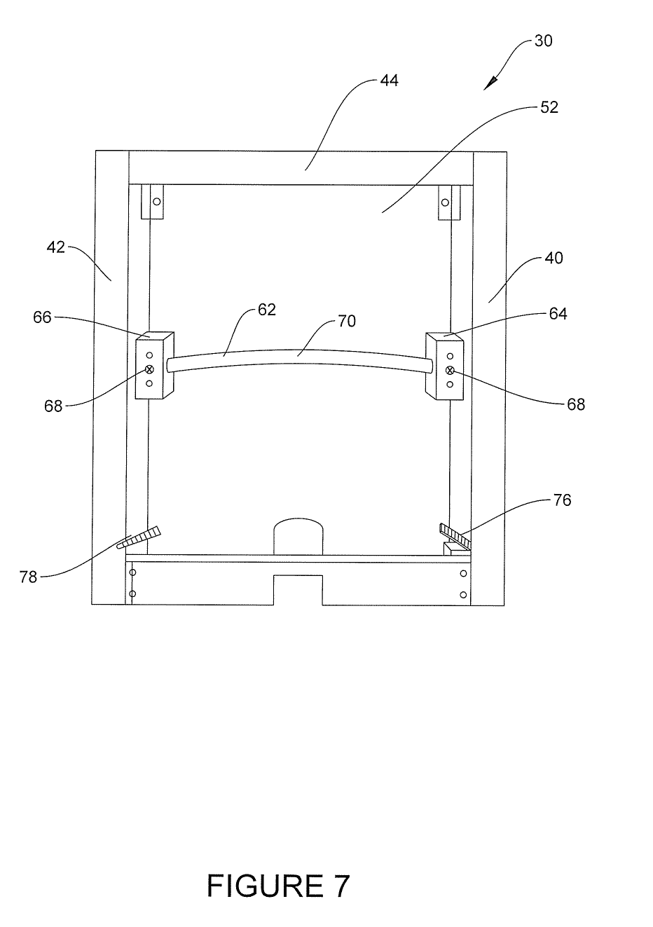

FIG. 7 shows a bottom underside perspective view of the container stand 30, with the underside of the ceiling 52 (the floor 38 is removed for this view), the right upper bias side 54, and the left upper bias side 56, along with the right side 40, left side 42 and back side 44.

The underside of the ceiling 52 also shows the bar assembly 62 comprising a right bar anchors 64 and a left bar anchor 66 and the screws 68 to hold the bar anchors 64, 66 into the underside of the ceiling 52. The bar 70 attaches to the right and left bar anchors 64, 66 and to the right side 40 and left side 42 at their respective right hole 72 and left hole 74 (see FIG. 5) to hold the ceiling 52 in the correct location during use.

Additionally, a right spring 76 and a left spring 78 are located and connected to the underside of the ceiling 52 and to the right upper bias side 54, the left upper bias side 56, respectively. The springs 76, 78 work to pull down and tilt or slant the ceiling 52 when the container 10 dispenses enough liquid 20. The right and left holes 72, 74 are positioned in such a way so that, when the bar 70 is placed in the holes 72, 74, the ceiling 52 will tilt when the enough of the liquid 20 in the container 10 on the stand 30 drops below the maximum threshold. At that point, the weight of the emptying container 10 has reduced enough such that the springs 76, 78 experience less resistance, and begin to pull down the front of the ceiling 52 and slant the container 10 forward, as described herein.

Other designs, configurations and methods for obtaining the same results are contemplated by the present disclosure. For example, springs can be located in the back side of the underside of the ceiling 52, such that as the liquid or beverage 20 is dispensed, the springs push the back of the ceiling 52 upwards, tilting or slanting the container 10 forward. Another embodiment of the present disclosure includes multiple holes on one or both of the right side 40 and left side 42 of the stand base 34, with corresponding holes in the side of the ceiling 52. With this configuration, as the liquid 20 in the container 10 is dispensed, the ceiling 52, which secures the container 10, can be manually moved to a first slanted position, based on the holes in the right side 40 and left side 42. A first holding device, such as a peg (not shown), etc. can be inserted through the right side 40, and if necessary, a second holding device can be inserted through the left side 42, to be further inserted into the side of the ceiling 52, which will then be held along with the container 10, in a slanted or angled position, allowing the dispensing of additional liquid 20. As more liquid 20 is removed from the container 10, the ceiling 52 can be further slanted (using second and third holes) to assist in the dispensing of additional liquid 20 out of the spigot 16. Of course, there are a number of ways in which the manual embodiment of the present disclosure can be accomplished with the same or similar slanting or sliding results.

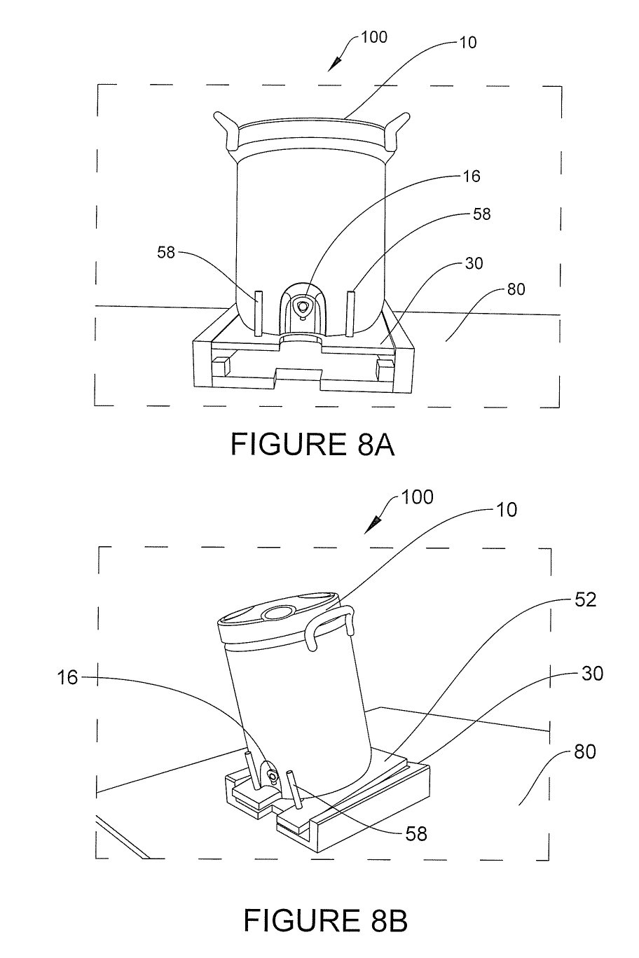

FIGS. 8A and 8B show the system 100 consisting of the container 10 and the container stand 30. When the container 10 is full of liquid or beverage and ice 20, etc., the ceiling 52 of the stand top 36 is level to the table 80 that the container stand is on (FIG. 8A). When the container 10 has dispensed much of the liquid or beverage 20, the system 100 reaches the maximum threshold and the ceiling begins to tilt along with the container 10, thereby allowing the liquid 20 in the container 10 to move forward to the spigot 16 where it can be dispensed through the spigot 16 (FIG. 8B). The extension rods 58 provide additional support to keep the container 10 from falling off of the container stand 30.

Accordingly, the container stand 30 is configured to accept and securely secure a container 10 with a spigot 16 that may be located an inch or more above the bottom 32 of the container 10. This configuration is such that when the spigot 16 is actuated to dispense the beverage 20, a small portion of the beverage 20 will not be dispensed. The container stand apparatus 30 is configured such that when the amount of beverage 20 inside the container body 12 reaches a maximum threshold, by weight or volume, the stand apparatus 30 will automatically begin to tilt or slope in a way that the beverage 20 inside will move toward the back side of the spigot 16, where the spigot 16 is connected to the container body 12.

When the spigot 16 is further depressed or actuated, the beverage 20 will be dispensed through the spigot 16, and as more beverage 20 is dispensed, the amount of beverage 20 in the container 10 will be further reduced, thereby reducing the weight on the container stand 30, allowing additional tilting or sloping of the container 10, until all or almost all of the beverage 20 has been removed through the spigot 16.

The extensions rods 58 or some other means to hold the container 10 in place during the automatic tilting process, can be permanently affixed to securely accept and hold the container or cooler 10, or the extensions rods 58 can be removable and can be relocated into other predrilled holes to accommodate different size coolers 10.

As such, the present disclosure is an improved container stand 30 that can be used with any size container or cooler 10 to automatically tilt and dispense all of the liquid or beverage 20 from the container 10 without leaving any liquid 20, or an extremely reduced amount, remaining in the container 10.

Reference throughout the specification to “various embodiments,” “some embodiments,” “one embodiment,” or “an embodiment,”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment.

Further, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional. Although numerous embodiments of this invention have been described above with a certain degree of particularity, those skilled in the art could make numerous alterations to the disclosed embodiments without departing from the spirit or scope of this disclosure.

All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A container stand for accepting and securely holding a container filled with a liquid and automatically slanting the container upon dispensing of the liquid through a spigot on the container, comprising:
a container stand base, and
a container stand top, said container stand top connected to said container stand base, said container stand top configured to accept and securely hold said container, wherein said container stand top will automatically tilt forward towards the spigot on said container as the liquid is dispensed from the container.

2. The container stand for accepting and securely holding a container filled with a liquid and automatically slanting the container upon dispensing of the liquid through a spigot on the container of claim 1, wherein said container stand base comprises a floor, a right side, a left side, a back side, a right lower bias side, and a left lower bias side.

3. The container stand for accepting and securely holding a container filled with a liquid and automatically slanting the container upon dispensing of the liquid through a spigot on the container of claim 1, wherein said stand top comprises a ceiling, a right upper bias side, a left upper bias side, and a holding structure.

4. The container stand for accepting and securely holding a container filled with a liquid and automatically slanting the container upon dispensing of the liquid through a spigot on the container of claim 3, wherein said holding structure is configured to hold and secure said container to the ceiling of said container stand top.

5. The container stand for accepting and securely holding a container filled with a liquid and automatically slanting the container upon dispensing of the liquid through a spigot on the container of claim 1, wherein said container stand top and container stand base are connected with a bar assembly.

6. The container stand for accepting and securely holding a container filled with a liquid and automatically slanting the container upon dispensing of the liquid through a spigot on the container of claim 5, wherein said bar assembly comprises a right bar anchor, a left bar anchor, and a bar, said right bar anchor is connected to said right side of said container stand, said left bar anchor is connected to said left side of said container stand, all attached to the underside of said ceiling.

7. The container stand for accepting and securely holding a container filled with a liquid and automatically slanting the container upon dispensing of the liquid through a spigot on the container of claim 3, wherein said holding structure comprises at least one extension rod.

8. The container stand for accepting and securely holding a container filled with a liquid and automatically slanting the container upon dispensing of the liquid through a spigot on the container of claim 2, wherein said floor of said container stand comprises a lower indent to facilitate filling large bottles or cups.

9. The container stand for accepting and securely holding a container filled with a liquid and automatically slanting the container upon dispensing of the liquid through a spigot on the container of claim 3, further comprising a right spring, said right spring having a first right spring side and a second right spring side, and a left spring, said left spring having a first left spring side and a second left spring side, said right spring being located and connected to the underside of the ceiling at the first right spring side and connected to the right upper bias side at the second right spring side, said left spring being located and connected to the underside of the ceiling at the first left spring side and connected to the left upper bias side at the second left spring side, such that the right and left springs pull down and tilt the ceiling when the container dispenses enough liquid to reduce the weight of the container past the maximum threshold.

10. A method of dispensing liquid from a container in which a container stand comprises a container stand base and a container stand top connected to said container stand base, said container stand accepts and securely holds said container filled with a liquid and automatically slants the container upon dispensing of the liquid through a spigot on the container, the steps comprising:
filling a container with said liquid;
placing said container on the container stand top; and
dispensing said liquid from said container, wherein said container stand top will tilt as the liquid is dispensed from the container, thereby tilting the container towards a spigot on the container.

11. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 10, wherein said container stand base comprises a floor, a right side, a left side, a back side, a right lower bias side, and a left lower bias side.

12. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 10, wherein said stand top comprises a ceiling, a right upper bias side, a left upper bias side, and a holding structure.

13. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 12, wherein said holding structure is configured to hold and secure said container to the ceiling of said container stand top.

14. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 10, wherein said container stand top and container stand base are connected with a bar assembly.

15. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 14, wherein said bar assembly comprises a right bar anchor, a left bar anchor, and a bar, said right bar anchor is connected to said right side of said container stand, said left bar anchor is connected to said left side of said container stand, all attached to the underside of said ceiling.

16. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 12, wherein said holding structure comprises at least one extension rod.

17. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 11, wherein said floor of said container stand comprises a lower indent to facilitate filling large bottles or cups.

18. The method of dispensing liquid from a container in which a container stand comprises a container stand base and a container stand top connected to said container stand base, said container stand accepts and securely holds said container filled with a liquid and automatically slants the container upon dispensing of the liquid through a spigot on the container of claim 12, further comprising a right spring, said right spring having a first right spring side and a second right spring side, and a left spring, said left spring having a first left spring side and a second left spring side, said right spring being located and connected to the underside of the ceiling at the first right spring side and connected to the right upper bias side at the second right spring side, said left spring being located and connected to the underside of the ceiling at the first left spring side and connected to the left upper bias side at the second left spring side, such that the right and left springs pull down and tilt the ceiling when the container dispenses enough liquid to reduce the weight of the container past the maximum threshold.
